(19) United States
(12) Patent Application Publication
(10) Pub. No.: US 2011/0054653 A1
(43) Pub. Date: Mar. 3, 2011

(54) METHOD AS TO WORK ON A PART TO BE FINISHED AND A FINISHED PART

(76) Inventor: Wilhelm Lange, Sandefjord (NO)

(21) Appl. No.: 12/552,062

(22) Filed: Sep. 1, 2009

(51) Int. Cl. G06F 19/00; G06F 17/50

(52) U.S. Cl. 700/98

(57) ABSTRACT

The present disclosure provides a method to machine a “to-be” body out of a raw part having at least one functional surface needing an allowance, whereas the method incorporates a “to-be” body, with the following process steps:
Capture the geometry of the raw body and its local position within a tooling machine and determine a virtual “as-is” body;
Make provision of a virtual allowance onto the virtual “to-be” body;
Virtually merge the virtual “as-is” body with the virtual “to-be” body; and
Calculate a virtual intersection of the virtual “as-is” body and the virtual “to-be” body and vary the relative position to each other such that the virtual intersection becomes a maximum.

### FIELD

The disclosure is concerned with a method as to work on a finished part, a finished part being produced according certain methods, and the finished part itself.

### BACKGROUND

The statements in this section merely provide background information related to the present disclosure and may not constitute prior art.

While working with a row part one has to expect to find material imperfections. Those material imperfections can for example be sand inclusions, dross, and the like. Material allowances have been made as to allow the removal of imperfections with the result of lower scrap. However this is not successful if the imperfection are large. Hence, functional surfaces do not achieve the needed quality criteria and the final part has to be scrapped. It is also quite ponderous to adjust the raw part into a tooling machine as to machine the final part completely. This is because reference points, fixtures, readings and the like deviate from raw part to raw part. Even with carefully measuring the raw part and with exact positioning of the raw part within the tooling machine the final part can partly be outside the raw part while machining. This leads to smaller wall thicknesses or even to holes in the finished part.

### SUMMARY

An underlying task of the present disclosure is therefore to present a method of reducing the above mentioned disadvantages.

This task will be achieved, in one form, with the characteristics described in claim 1 of this application.

The raw part can be a round bar, semifinished product, or a casting. Of this raw part we capture the geometry and we construct a virtual “as-is” body. The virtual “as-is” body represents the real individual 3 dimensional raw part in the form of an electronic file, especially in form of a 3 dimensional (3D) CAD (Computer Aided Design)-file made available electronically. With the same token beside having the 3-dimensional data of the raw part we also get the distance data and the position data within the tooling machine, as to have available the exact position of the raw part within the tooling machine.

We also have the 3-dimensional data file of the finished part defining the “to-be” part to which we add a virtual allowance. This virtual allowance will especially be used in regions where we later on have special functions to fulfill as to make sure that during the following machining we achieve a high surface quality.

Both 3-dimensional data files, e.g. the virtual file of the “to-be” body and the virtual file of the “as-is” part, will be fitted into each other in a virtual manner. This is done by shifting the virtual “to-be” body into the virtual “as-is” body based on the recorded distance data and position data. The reference points and the fixture positions will be adjusted as needed. By varying the relative positions of both virtual bodies and through calculating the maximum virtual intersection we can make sure that too small wall thicknesses of the final part will be kept to a minimum after machining. It is of special advantage with this method that the relative position of the final part and the raw part is optimized for machining.

This method will shift the “to-be” body into the “as-is” body. However, both methods just achieve shifting the “to-be” body into a peripheral zone of the “as-is” body. To get a more favorable central position of the “to-be” body within the “as-is” body (including added allowances) we add mass to the surface outside in the radial direction, where the added mass is getting smaller with the radial distance—however the radial distance is limited be the surface of the “as-is” body. Maximizing the total mass of the “to-be” body, plus mass of the allowance plus added mass decreasing with radial distance, we achieve a better central position.

It is planned in a further step of this method that the virtual intersection of the volume of the “as-is” body and the “to-be” body (mathematically spoken: AND combination) will be calculated and that the virtual addition is a volume addition. The relative position of the “as-is body and the “to-be” body will be varied until the intersection volume of both parts reaches a maximum. This means that the latter final part inclusive its added allowances are within the raw part. The variation of the relative position of both parts is particular based on the calculation of the total differential of the combined volumes, where the partial derivatives of the combined volumes relative to the three space coordinates and to the three angle coordinates build the sensitivities of the combined volume. Especially used is the gradient method.

As an alternative we also can minimize the combined intersection volume (mathematically spoken: OR combination) of the “as-is” body and the “to-be” body. Again we in this way shift the “to-be” body into the “as-is” body. Both methods however only achieve shifting the “to-be” body into a peripheral zone of the “as-is” body. As to achieve a more favorable central position of the “to-be” body within the “as-is” body we virtually add onto the surface (including the added allowance) of the “to-be” body a radial decreasing additional mass however limited by the surface of the “as-is” body. If we then maximize the total intersection mass of the in this way modified “to-be” body, we achieve a more favorable central position. As well we can use “volume” instead of “mass”. We just need to make sure that the added volume again gets a weighing decreasing with radial distance. To use mass however is easier to grasp as it is easier to imagine a reduced density.

A further variant of the method makes the reservation to include material imperfections in the raw part being included into the virtual “as-is” body. Talking about material imperfections we are thinking of sand inclusions or dross being outside of critical zones as for example close to the surface, or can also be within highly loaded zones. Sand inclusion stem from the process of pouring the casting, if we have a casting, being locked within the structure of the metal or are locked close to the surface of the casting. Dross is a non-metallic compound having an irregular structure as we have it for example as slag. It is here of advantage to move the material imperfections of the virtual “as-is” body into a relative position of the “to-be” body such that the material imperfection will be outside of functional surfaces, or outside of critical zones as for example close to the surface, or outside of highly stressed zones. In this way we ensure that the functional surface of the machined part is showing a high degree of quality. If we encounter a high number of material imperfections, we can optimize in such a way that huge material imperfections are moved outside of functional surfaces or outside of highly stressed zones. The optimization can also shift a imperfection from a critical zone into a less critical zone. Often shrinkage of castings is unacceptable if they are positioned close to the surface while the same shrinkage is acceptable in the middle of the wall.

Further on it is of advantage if the relative position of the “to-be” body and the “as-is” body is varied automatically and/or manually. It is especially advantageous if due to automatically varying the relative position of the “to-be” body and the “as-is” body happens in the tooling machine as to fit both parts into each other. An additional option of the operator is to vary the “to-be” body and the “as-is” body manually if for example automatically varying is not possible. This can be the case if due to numerous material imperfections being unfavorable distributed that automatically optimization will not find a solution. In this case it is of advantage if the provision is made to have a CAD interface. This provision allows machining the raw part within a tooling machine as well as critical zones can be shown in a visual manner. In the latter case we are in the position to judge material imperfections quite sophisticated and we can vary the relative position of both bodies manually.

To capture the geometry of the raw part we can for example scan (while touching the raw part) different reference points and the material imperfections we can capture for example by using ultrasonic testing or X-raying. It is however preferred a further development of the method by catching the external geometry with a scanner (non-touching). This allows a cost effective and fast capture of the geometry of the raw part. It is of advantage if in this latter case the scanner is led by a robot, allowing scanning the “as-is” body in a clamped position, e.g. we don't need to clamp again after the scanning. This improves the exactness further on.

The task is completed further with a machined part as described above being machined from a raw part. In this way it is made sure that functional surfaces show a superior surface quality as well as a high exactness.

Finally it is planned to use this method on a raw part being a casting. It is especially of advantage that this invented method is applied on a raw part, where we typically find material imperfections—applying this method ensures a high degree of exactness of the geometry as well as the surface quality of functional surfaces is improved.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1: a schematic representation of a method according to the present disclosure; and

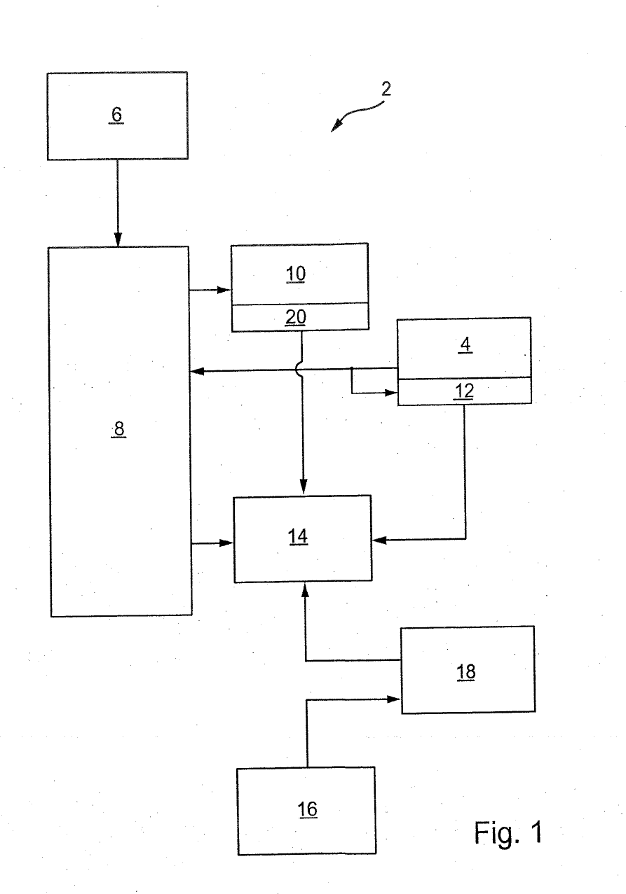

FIGS. 2a through 2c: a schematic portrayal of individual process steps of a method according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

The drawings show in a schematic way a method 2 to machine a product. The product will be machined out of a raw part 3 which at least has to be machined surface and an allowance 5. The method 2 utilizes a virtual “to-be” body 4 being stored electronically as a 3D-datafile, and in one form as a 3D-CAD-datafile. The “to-be” body 4 is here a virtual representation of the latter product being the result of machining. In a first step of the process we capture the geometry of the raw part 3 as well as we capture the local position within the tooling machine, for example by usage of a scanner 6. The recorded data will be transmitted to a computer 8 being stored as “as-is” body 10. The computer 8 adds in the following step an allowance 12 onto the “to-be” body 4. Virtual “as-is” body 10 and virtual “to-be” body 4 now will be fitted into each other in a virtual manner. This is done by utilizing the local position of the “as-is” body 10 and shifting the “to-be” body 4 into the “as-is” body 10 until they are merged completely.

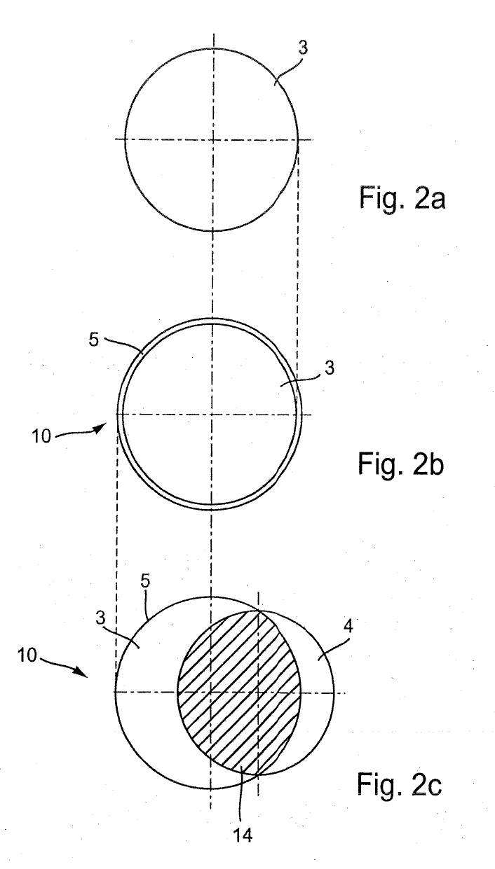

FIGS. 2a through 2c portray schematically the individual process steps. In FIG. 2a we capture the geometry of the raw part 3 as well as its local position. In a virtual manner we then add an allowance 5 according to FIG. 2 onto the “to-be” body 4 whereas the virtual allowance 5 either can be a volume addition or a mass addition. In this way we get the “to-be” body 4. FIG. 2c shows how then the “to-be” body 4 is fitted into the “as-is” body whereas both parts intersect only partially and build an intersection 14.

The computer 8 calculates the virtual intersection 14. Then the “to-be” body 4 and the “as-is” body 10 vary the relative position such that the intersection 14 becomes a maximum. The intersection 14 can be calculated with the computer 8. However, through the CAD interface there is the option of the operator 16 being able to vary the position of the “to-be” body 4 manually.

Through the production method the “as-is” body 10 can have material imperfections 20 being detected through scanning the raw part 3 and visualized as incorporated virtually into “to-be” body 10. As we calculate the intersection 14 of the “as-is” body 10 and the “to-be” body 4 we take care of the material imperfections 20 in such a way that the relative position of the “as-is” body 10 and the “to-be” body 4 is such that functional surfaces show no or at least only a small number of material imperfections 20 and hence are not critical anymore.

Through the method 2 we can achieve a product having an especial high surface quality.

It should be noted that the disclosure is not limited to the embodiments described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A method to machine a product out of a raw part which at least has one surface to be machined and has a functional surface in need of an allowance, whereas the method utilizes a virtual “to-be” body of the product, having the following process steps:
a. capturing the geometry of the raw part, and if applicable its local position within the tooling machine, and processing a virtual “as-is” body;
b. make provisions for a virtual allowance onto the virtual “to-be” body;
c. merge virtually the virtual “to-be” body into the virtual “as-is” body; and
i. calculate a virtual intersection (mathematically defined as “AND” combination) of the virtual “to-be” body and the virtual “as-is” body, and vary the relative position of both virtual bodies in a way that the virtual intersection is a maximum; or
ii. calculate a combined intersection volume (mathematically spoken: OR combination) of the “as-is” body and the “to-be” body and vary the relative position of both virtual bodies in a way that the virtual intersection is a minimum.

2. The method according claim 1, characterized by adding mass to the surface outside of the “to-be” body in the radial direction, where the added mass is getting smaller with the radial distance—however the radial distance is limited be the surface of the “as-is” body.

3. The method according claim 2, characterized by calculating the virtual intersection of the mass of the “as-is” body and the “to-be” body (mathematically spoken: AND combination) and that the virtual addition is an allowance plus a mass addition, wherein the relative position of the “as-is body and the “to-be” body will be varied until the intersection volume of both bodies reach a maximum.

4. The method according to claim 1, characterized by calculating the virtual intersection of the volume of the “as-is” body and the “to-be” body with the virtual allowance being a volume addition.

5. The method according to claim 1, characterized in that the intersection of the mass of the “as-is” body and the “to-be” body is calculated and that the virtual addition is a mass addition.

6. The method according to claim 1, characterized by capturing a material imperfection within the raw part and making it visible within the “as-is” body.

7. The method according claim 6, characterized by moving the virtual “as-is” body in a position relative to the “to-be” body that the material imperfection of the virtual “as-is” body is positioned outside of the functional surface of the virtual “to-be” body.

8. The method according to claim 1, characterized in that varying the relative position of the “to-be” body and the “as-is” body is being done by at least one of automatically and manually.

9. The method according to claim 1, further comprising providing a CAD interface.

10. The method according to claim 1, further comprising capturing the geometry of the raw part with a scanner.

11. The method according to claim 10, wherein the scanner is guided with a robot.

12. The method according to claim 1, wherein the raw part is a casting.

13. A part machined according to the method of claim 1.

14. The part according to claim 13, wherein the raw part is a casting.
